(19) United States
(12) Patent Application Publication
(10) Pub. No.: US 2019/0310206 A1
(43) Pub. Date: Oct. 10, 2019

(54) DUST DETECTION APPARATUS AND METHOD OF MANUFACTURING THE SAME

(71) Applicant: ITM SEMICONDUCTOR CO., LTD., Chungcheongbuk-do (KR)

(72) Inventors: Hyuk Hwi NA, Chungcheongbuk-do (KR); Ho Seok HWANG, Gyeonggi-do (KR); Dong Hee LEE, Chungcheongbuk-do (KR); Jong Sik JANG, Chungcheongbuk-do (KR)

(21) Appl. No.: 16/373,708

(22) Filed: Apr. 3, 2019

(30) Foreign Application Priority Data
Apr. 5, 2018 (KR) 10-2018-0039953
Nov. 16, 2018 (KR) 10-2018-0141743

(51) Int. Cl. G01N 21/94; G01N 21/53

(52) U.S. Cl. CPC G01N 21/94; G01N 2021/473; G01N 21/53

(57) ABSTRACT

Provided are a dust detection apparatus a method of manufacturing the same, and the dust detection apparatus may include a body capable of sucking in or discharging air containing dust, by using a fan, and including a fluidic channel through which the sucked air flows, a light emitter provided in the body to radiate a light signal by using a laser device, a lens provided in the body to concentrate the light signal radiated from the laser device, a light receiver provided in the body to detect scattered light generated when the radiated light signal is scattered by the dust in the air, a substrate provided in the body to mount electronic components thereon, and a shield case surrounding the body to be at least partially in contact with the substrate.

### CROSS-REFERENCE TO RELATED PATENT APPLICATIONS

This application claims the benefit of Korean Patent Application No. 10-2018-0039953, filed on Apr. 5, 2018, and Korean Patent Application No. 10-2018-0141743, filed on Nov. 16, 2018, in the Korean Intellectual Property Office, the disclosures of which are incorporated herein by reference in their entireties.

### BACKGROUND

### 1. Field

The present invention relates to a dust detection apparatus and a method of manufacturing the same and, more particularly, to a dust detection apparatus for detecting scattered light, and a method of manufacturing the same.

### 2. Description of the Related Art

A variety of electronic devices such as air cleaners, portable dust meters, and smart devices generally use a light sensor using an infrared or laser beam and including a light emitter and a light receiver, and dust detection apparatuses for the size or concentration of dust contained in the air are being produced based on application of the light sensor.

A dust detection apparatus includes a light emitter for radiating a light signal, a condenser located on an optical path of the light signal to concentrate the light signal, a light receiver for receiving scattered light, and a sensor for amplifying a signal output from the light receiver, and determining a dust concentration by using a microcomputer.

The sensor uses a circuit for amplifying a signal several hundred to several thousand times, to detect a small scattered light signal. In this case, a shield case and a ground structure for cancelling external noise are critical elements of the sensor.

### SUMMARY

In a general dust sensor using a laser device as a light source, a ground terminal on a printed circuit board (PCB) is connected to a metallic shield case outside a product by using a conductive spring.

In this case, contact resistance occurs between the spring and the PCB or the shield case and thus noise is not completely cancelled, and external noise is also amplified when an amplification circuit is used. In addition, the contact resistance may be increased due to corrosion of the spring.

Furthermore, as a fan for sucking in the external air into the sensor, a high-speed fan is used to sufficiently obtain scattered light but reduces a lifespan and increases noise.

Besides, in the general dust sensor using a light emitter and a light receiver which are separately injection-molded and fixed, error occur in an optical structure, the scattered light signal delivered to the light receiver is dependent on directly reflected light, and costs for designing a circuit for amplifying a small light signal are increased.

The present invention provides a dust detection apparatus capable of reducing ground resistance and increasing a noise cancellation effect by directly assembling a shield case to a ground terminal of a printed circuit board (PCB) without using any medium such as a spring by applying the shield case including a ground connector, to a dust sensor, and a method of manufacturing the dust detection apparatus.

The present invention also provides a dust detection apparatus capable of sufficiently obtaining scattered light by using a low-speed fan by forming a fluidic channel in a Venturi structure, of reducing costs for designing a circuit for amplifying a light signal, by sufficiently receiving reflected light other than directly reflected light by concentrating the scattered light, and of minimizing errors of a light emitter and a light receiver by integrating the light emitter (e.g., a laser device) and the light receiver with one body. However, the above-described effects are merely examples, and the scope of the present invention is not limited thereto.

According to an aspect of the present invention, there is provided a dust detection apparatus including a body capable of sucking in or discharging air containing dust, by using a fan, and including a fluidic channel through which the sucked air flows, a light emitter provided in the body to radiate a light signal by using a laser device, a lens provided in the body to concentrate the light signal radiated from the laser device, a light receiver provided in the body to detect scattered light generated when the radiated light signal is scattered by the dust in the air, a substrate provided in the body to mount electronic components thereon, and a shield case surrounding the body to be at least partially in contact with the substrate.

The shield case may include a ground connector at least partially bent into the body to be in direct contact with a ground terminal on the substrate.

The body may include a plurality of fixing protrusions provided on side walls of the body, and the shield case may include a plane part corresponding to a surface of the body, a side part corresponding to the side walls of the body, and a plurality of case fixing holes provided in the side part in a shape corresponding to the fixing protrusions so as to fix the shield case to the body.

The shield case may include a first case covering a lower part of the body, and a second case covering an upper part of the body, and wherein at least a part of at least any one of the first and second cases may be in contact with the substrate.

The body may include a fixing part exposed to outside of the shield case to be fixed to an external device.

According to another aspect of the present invention, there is provided a dust detection apparatus including a body capable of sucking in or discharging air containing dust, by using a fan, and including a fluidic channel through which the sucked air flows at a variable velocity, a light emitter provided in the body to radiate a light signal by using a laser device, a lens provided in the body to concentrate the light signal radiated from the laser device, a light receiver provided in the body to detect scattered light generated when the radiated light signal is scattered by the dust in the air, and a body cover including a condenser capable of concentrating the scattered light on the light receiver, and provided at a side of the body.

The body may include a partition for dividing the body into a first region accommodating a substrate and a second region including the fluidic channel where the scattered light is generated, to detect the scattered light without interference with the substrate having electronic components mounted thereon.

The condenser may include a concave part in a direction opposite to a direction toward the light receiver with respect to the fluidic channel to concentrate the light scattered in a direction different from the direction toward the light receiver, and reflect the scattered light incident on the concave part, to the light receiver.

The dust detection apparatus may further include a shield case surrounding the body.

The body may include an inlet capable of sucking in the air containing dust, from a partial region of at least any one of external surfaces of the body, an outlet capable of discharging the air containing dust, from a partial region of at least any one of the external surfaces of the body, a light emitter container capable of accommodating the light emitter, a lens container capable of accommodating the lens, a light receiver container capable of accommodating the light receiver, a substrate container for accommodating a substrate having electronic components mounted thereon, and a fluidic channel part formed in such a manner that the air sucked into the inlet passes through the light signal and is discharged from the outlet.

The fluidic channel part may include a low-velocity part where the fluidic channel has a first cross-sectional area, and a high-velocity part where the fluidic channel has a second cross-sectional area less than the first cross-sectional area to achieve a higher velocity of the air compared to the low-velocity part.

The light emitter container and the light receiver container may be integrated with each other to uniformly deliver the light signal to the light receiver.

The dust detection apparatus may further include a sensor for amplifying a signal output from the light receiver, and determining a dust concentration by using a microcomputer.

According to another aspect of the present invention, there is provided a method of manufacturing a dust detection apparatus, the method including a shield case preparation operation for preparing a shield case including a first case capable of covering a lower part of a body and a second case capable of covering an upper part of the body, a body preparation operation for preparing the body including a fluidic channel part formed in such a manner that air sucked into an inlet passes through a light signal and is discharged from an outlet, a first case coupling operation for bending the first case to be coupled to and to cover the upper part of the body, a ground connector forming operation for bending at least a part of a ground connector of the first case into the body, a substrate assembly operation for assembling a substrate having electronic components mounted thereon, to the body in such a manner that a ground terminal on the substrate is in contact with the ground connector, and a second case coupling operation for coupling and covering the second case 62 to and on the lower part of the body.

The method may further include, after the body preparation operation, a light emitter assembly operation for assembling a light emitter for radiating a light signal by using a laser device, to the body, a lens assembly operation for assembling a lens capable of concentrating the light signal radiated from the laser device, to the body, and a light receiver assembly operation for assembling a light receiver for detecting scattered light generated when the radiated light signal is scattered by dust in the air, to the body.

### BRIEF DESCRIPTION OF THE DRAWINGS

The above and other features and advantages of the present invention will become more apparent by describing in detail embodiments thereof with reference to the attached drawings in which:

FIG. 1 is a perspective view of a dust detection apparatus according to an embodiment of the present invention;

FIG. 2 is an exploded perspective view of the dust detection apparatus according to an embodiment of the present invention;

FIG. 3 is a perspective view of a first case of the dust detection apparatus according to an embodiment of the present invention;

FIG. 4 is a perspective view of a second case of the dust detection apparatus according to an embodiment of the present invention;

FIG. 5 is a perspective view of a body of the dust detection apparatus according to an embodiment of the present invention;

FIG. 6 is another perspective view of the body of the dust detection apparatus according to an embodiment of the present invention;

FIG. 7 is a perspective view of a dust detection apparatus according to another embodiment of the present invention;

FIG. 8 is an exploded perspective view of the dust detection apparatus according to another embodiment of the present invention;

FIG. 9 is a perspective view of a body of the dust detection apparatus according to another embodiment of the present invention;

FIG. 10 is another perspective view of the body of the dust detection apparatus according to another embodiment of the present invention;

FIG. 11 is a perspective view of a body cover of the dust detection apparatus according to another embodiment of the present invention;

FIG. 12 is a cross-sectional view of a condenser of FIG. 11;

FIG. 13 is a flowchart of a method of manufacturing the dust detection apparatus, according to an embodiment of the present invention;

FIG. 14 is a flowchart of a method of manufacturing the dust detection apparatus, according to another embodiment of the present invention;

FIG. 15 is a perspective view showing a shield case preparation operation of the method of manufacturing the dust detection apparatus;

FIG. 16 is a perspective view showing a body preparation operation of the method of manufacturing the dust detection apparatus;

FIG. 17 is a perspective view showing a first case coupling operation of the method of manufacturing the dust detection apparatus;

FIG. 18 is a perspective view showing a ground connector forming operation of the method of manufacturing the dust detection apparatus;

FIG. 19 is a magnified view of a ground connector formed in the ground connector forming operation of FIG. 18;

FIGS. 20 and 21 are perspective views showing a substrate assembly operation of the method of manufacturing the dust detection apparatus; and

FIG. 22 is a perspective view showing a second case coupling operation of the method of manufacturing the dust detection apparatus.

### DETAILED DESCRIPTION

Hereinafter, the present invention will be described in detail by explaining embodiments of the invention with reference to the attached drawings.

The invention may, however, be embodied in many different forms and should not be construed as being limited to the embodiments set forth herein; rather, these embodiments are provided so that this disclosure will be thorough and complete, and will fully convey the concept of the invention to one of ordinary skill in the art. In the drawings, the thicknesses or sizes of layers are exaggerated for clarity.

It will be understood that when an element, such as a layer, a region, or a substrate, is referred to as being “on”, “connected to”, “stacked on” or “coupled to” another element, it may be directly on, connected to, stacked on or coupled to the other element or intervening elements may be present. In contrast, when an element is referred to as being “directly on”, “directly connected to” or “directly coupled to” another element or layer, there are no intervening elements or layers present. Like reference numerals denote like elements throughout. As used herein, the term “and/or” includes any and all combinations of one or more of the associated listed items.

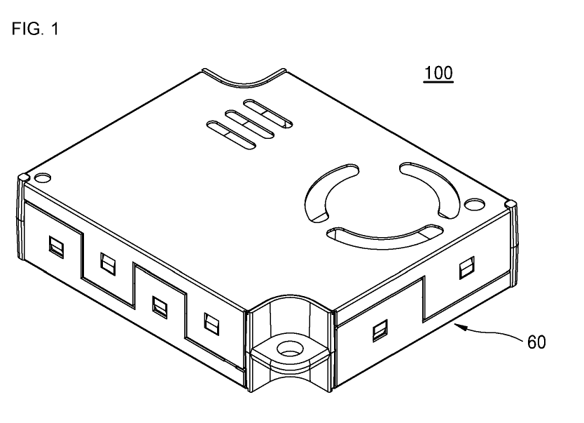

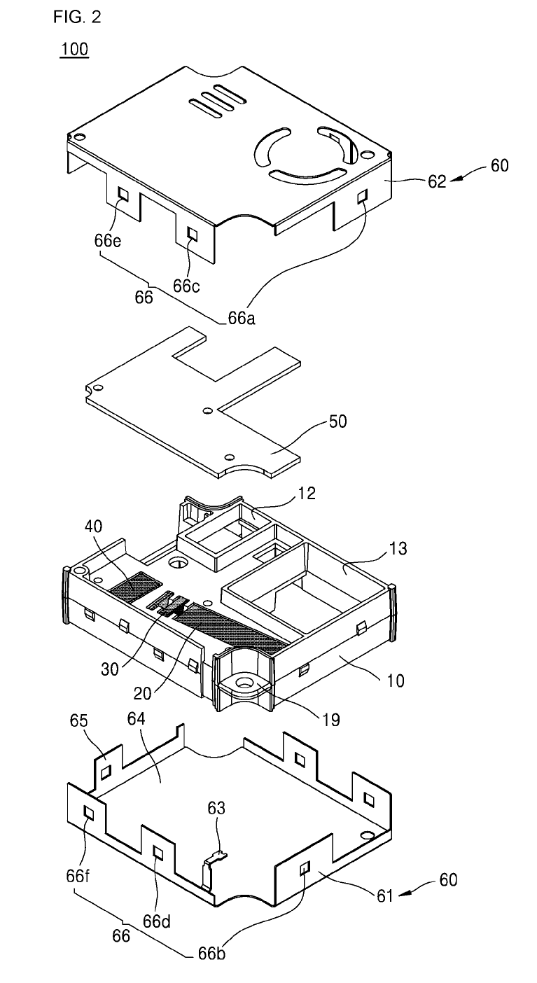

FIG. 1 is a perspective view of a dust detection apparatus 100 according to an embodiment of the present invention, and FIG. 2 is an exploded perspective view of the dust detection apparatus 100 according to an embodiment of the present invention.

Initially, as illustrated in FIGS. 1 and 2, the dust detection apparatus 100 according to an embodiment of the present invention may include a body 10, a light emitter 20, a lens 30, a light receiver 40, a substrate 50, and a shield case 60.

As illustrated in FIGS. 1 and 2, the dust detection apparatus 100 may have a hexahedron shape including the body 10 capable of detecting dust. An inlet capable of sucking in the air containing dust may be provided in at least one surface of the hexahedron shape, and an outlet capable of discharging the air may be provided in at least one surface of the hexahedron shape. In addition to the hexahedron shape, the dust detection apparatus 100 may have various shapes such as a pillar shape (e.g., a cylinder shape or a polygonal prism shape), a corn or pyramid shape, and a plate shape so as to be installable at various places, and include an air inlet and an air outlet in at least a part thereof.

As illustrated in FIG. 2, the body 10 may suck in or discharge the air containing dust, by using a fan, and include a fluidic channel through which the sucked air flows.

The body 10 may include a light emitter container, a lens container, a light receiver container, a substrate container, a fluidic channel part, and a fixing part, and detailed descriptions thereof will be provided below.

As illustrated in FIG. 2, the light emitter 20 may be provided in the body 10 to radiate a light signal by using a laser device.

The light emitter 20 may be a laser device, and a sensor may control the light emitter 20 to radiate a light signal onto one point of the fluidic channel in in the body 10 by applying a control signal to the light emitter 20. The light signal radiated from the light emitter 20 may be a laser beam and may be scattered and generate scattered light when colliding with dust particles contained in a fluid. The scattered light may be incident on and detected by the light receiver 40, and thus an electrical detection signal may be transmitted to and collected by the sensor.

As illustrated in FIG. 2, the lens 30 may be provided in the body 10 to concentrate the light signal radiated from the laser device.

The lens 30 may concentrate or parallelize the light signal radiated from the light emitter 20, to proceed to the dust in the air.

As illustrated in FIG. 2, the light receiver 40 may be provided in the body 10 to detect the scattered light generated when the radiated light signal is scattered by the dust in the air.

The light receiver 40 may detect the scattered light generated when the light signal radiated from the light emitter 20 onto one point of the fluidic channel collides with the dust particles contained in the fluid, and thus information about whether dust is present or about the amount of dust may be transmitted to and collected by the sensor.

As illustrated in FIG. 2, the substrate 50 may be provided in the body 10 to mount electronic components thereon. The substrate 50 may be electrically connected to the light emitter 20 and the light receiver 40. The dust detection apparatus 100 may further include a sensor for amplifying a signal output from the light receiver 40, and determining a dust concentration by using a microcomputer.

The sensor may be a controller for controlling the light emitter 20 and the light receiver 40, and may control the light emitter 20 to radiate the light signal onto one point of the fluidic channel by applying an output signal thereof to the light emitter 20.

The controller may further include an amplifier for amplifying the scattered light signal, and a corrector for removing noise from the scattered light signal.

As illustrated in FIG. 2, the shield case 60 may surround the body 10 to be at least partially in contact with the substrate 50. The shield case 60 may include a plane part 64, a side part 65, and case fixing holes 66 to cover the body 10.

For example, the plane part 64 of the shield case 60 may be provided to correspond to a surface of the body 10, the side part 65 may be provided to correspond to side walls of the body 10, and a plurality of case fixing holes may be provided in the side part 65 in a shape corresponding to fixing protrusions on the body 10 so as to fix the shield case 60 to the body 10.

Specifically, the shield case 60 may include a first case 61, a second case 62, and a ground connector 63 at least partially bent into the body 10 to be in direct contact with a ground terminal on the substrate 50.

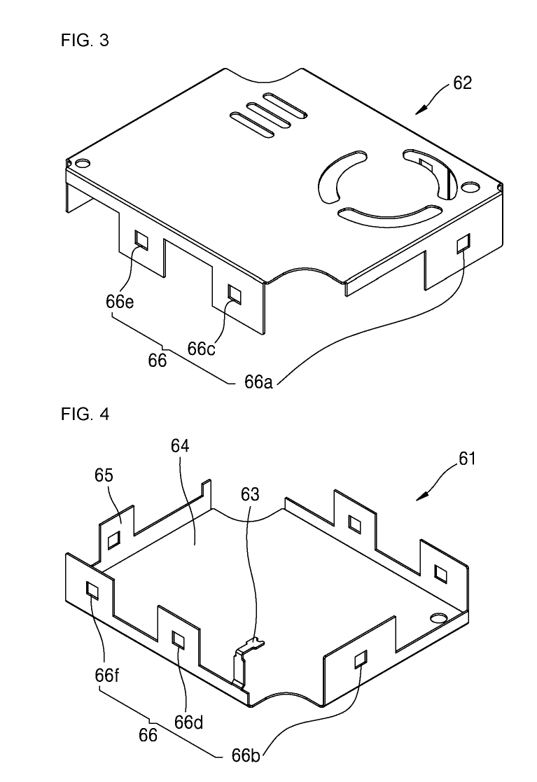

FIGS. 3 and 4 are perspective views of the first and second cases 61 and 62 of the dust detection apparatus 100 according to an embodiment of the present invention.

As illustrated in FIGS. 3 and 4, the first case 61 may cover a lower surface of the body 10, the second case 62 may cover an upper surface of the body 10, and at least a part of at least any one of the first and second cases 61 and 62 may be in contact with the substrate 50.

Specifically, the first case 61 may further include the plane part 64 corresponding to and covering a surface of the first case 61 to cover and shield the body 10, the side part 65 surrounding the side walls of the body 10, case fixing holes 66 bored to couple the body 10 to the first case 61, and the ground connector 63 extending from a side of the first case 61 to a certain length and bent into the body 10 to be in contact with the substrate 50.

By assembling the first case 61 to the body 10 to achieve direct contact between the ground connector 63 and the substrate 50 without providing any medium between the first case 61 and the substrate 50, a ground resistance may be reduced and a noise cancellation effect may be increased.

The second case 62 may further include another plane part corresponding to and covering another surface of the body 10, another side part surrounding the side walls of the body 10, and case fixing holes 66 for coupling the body 10 to the second case 62.

The case fixing holes 66 provided in the first and second cases 61 and 62 may include a plurality of case fixing holes 66a, 66b, 66c, 66d, 66e, and 66f for fixing the shield case 60 to the body 10.

In this case, a plurality of case fixing holes 66b, 66d, and 66f of the first case 61 and a plurality of case fixing holes 66a, 66c, and 66e of the second case 62 may alternate with each other to alternately and firmly couple the first and second cases 61 and 62 to the body 10, and thus the durability of the dust detection apparatus 100 may be increased.

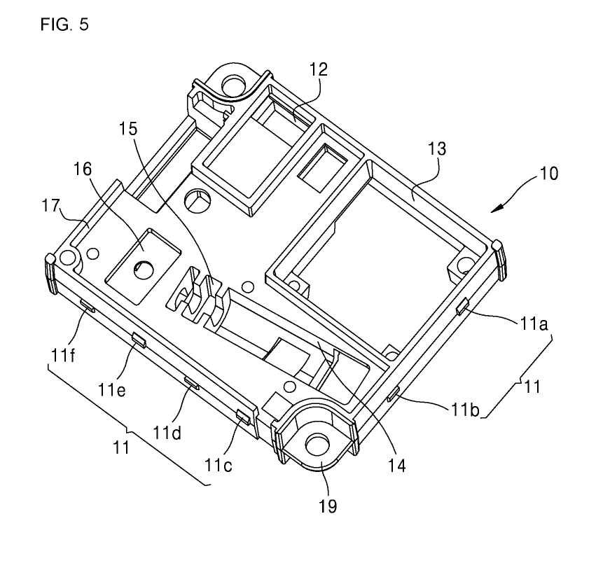

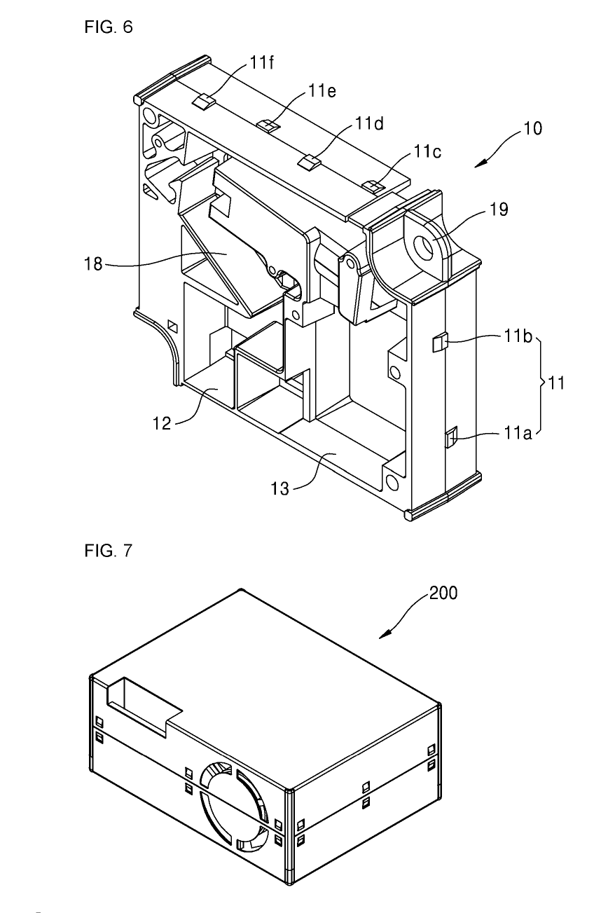

FIG. 5 is a perspective view of the body 10 of the dust detection apparatus 100 according to an embodiment of the present invention, and FIG. 6 is another perspective view of the body 10.

As illustrated in FIGS. 5 and 6, the body 10 may include fixing protrusions 11, an inlet 12, an outlet 13, a light emitter container 14, a lens container 15, a light receiver container 16, a substrate container 17, a fluidic channel part 18, and a fixing part 19.

As illustrated in FIGS. 5 and 6, the body 10 may include a plurality of fixing protrusions 11 provided on the side walls thereof. The fixing protrusions 11 may include a plurality of fixing protrusions 11a, 11b, 11c, 11d, 11e, and 11f for fixing the body 10 to the shield case 60.

Specifically, the fixing protrusions 11a, 11b, 11c, 11d, 11e, and 11f of the body 10 illustrated in FIG. 5 may be correspondingly coupled to the plurality of case fixing holes 66a, 66b, 66c, 66d, 66e, and 66f illustrated in FIGS. 3 and 4.

That is, the fixing protrusion 11a in a protrusion shape may be inserted into and coupled to the case fixing hole 66a bored through the second case 62. In this manner, the fixing protrusions 11a, 11b, 11c, 11d, 11 e, and 11f having the same shape may be coupled to the case fixing holes 66a, 66b, 66c, 66d, 66e, and 66f to firmly couple the first and second cases 61 and 62 to the body 10.

The body 10 may further include a ground connector guide at a side of the body 10 in such a manner that the ground connector 63 of the shield case 60 may be in direct contact with the substrate 50 provided in the body 10. As such, the ground connector 63 extending from a side of the shield case 60 to a certain length may be bent along and guided by the ground connector guide to be in contact with a ground terminal on the substrate 50.

As illustrated in FIGS. 5 and 6, the body 10 may suck in or discharge the air containing dust, by using a fan, and include a fluidic channel through which the sucked air flows.

The inlet 12 may suck in the air containing dust, from a partial region of at least any one of external surfaces of the body 10, and the outlet 13 may discharge the air containing dust, from a partial region of at least any one of the external surfaces of the body 10.

For example, a fan container capable of accommodating the fan may be provided at a side of the body 10, and the fan may be driven to suck in the air from outside the dust detection apparatus 100 through the inlet 12 or to discharge the sucked air through the outlet 13.

The air sucked into the inlet 12 may move along the fluidic channel in the body 10. In this case, the fluidic channel may form a non-uniform fluidic channel from the inlet 12 to the outlet 13 such that the sucked air may flow at a variable velocity.

As illustrated in FIGS. 5 and 6, the inlet 12 may suck in the air containing dust, from a partial region of at least any one of external surfaces of the body 10, and the outlet 13 may discharge the air containing dust, from a partial region of at least any one of the external surfaces of the body 10.

The inlet 12 may have various shapes capable of interconnecting external and internal spaces of the body 10, and include a fan for sucking in the air from outside the dust detection apparatus 100.

The inlet 12 may include a shield at a side thereof to block penetration of external light into the body 10 such that the air may be sucked through the inlet 12 into the body 10 and light may not penetrate into the body 10.

The outlet 13 may discharge the sucked air. When the fan is driven, the air may be continuously sucked into the inlet 12, flow through the fluidic channel, and be discharged from the outlet 13 without using any driving device for discharging the air.

That is, the fan may perform both of the air suction function and the air discharge function.

The outlet 13 may include a shield at a side thereof to block penetration of external light into the body 10 such that the air may be discharged from the body 10 through the outlet 13 and light may not penetrate into the body 10.

As illustrated in FIG. 5, the light emitter container 14 may accommodate the light emitter 20, and have a shape corresponding to the light emitter 20 to accommodate the light emitter 20. The light emitter container 14 may further include a light emitter holder for fixing the light emitter 20 in such a manner that a light signal is uniformly radiated from the light emitter 20.

As illustrated in FIG. 5, the lens container 15 may accommodate the lens 30, and have a shape corresponding to the lens 30 to accommodate the lens 30. The lens container 15 may further include a lens holder for fixing the lens 30 in such a manner that the light signal is uniformly radiated onto the lens 30 from the light emitter 20.

As illustrated in FIG. 5, the light receiver container 16 may accommodate the light receiver 40, and have a shape corresponding to the light receiver 40 to accommodate the light receiver 40. The light receiver container 16 may further include a light receiver holder for fixing the light receiver 40 in such a manner that the light signal is uniformly radiated onto the light receiver 40 through the lens 30 from the light emitter 20.

The light emitter container 14 and the light receiver container 16 may be integrated with each other to uniformly deliver the light signal to the light receiver 40.

Specifically, the body 10 including the light emitter container 14 and the light receiver container 16 may be injection-molded as a single product such that the light emitter 20 accommodated in the light emitter container 14 and the light receiver 40 accommodated in the light receiver container 16 may be fixed without any error and more of the scattered light generated when the light signal radiated from the light emitter 20 is scattered may be received by the light receiver 40.

As illustrated in FIG. 5, the substrate container 17 may accommodate the substrate 50 having electronic components mounted thereon, and be provided in a space different from the fluidic channel in such a manner that the substrate 50 does not interfere with the fluidic channel through which the air flows.

For example, the fluidic channel including one point where the radiated light signal collides with the dust in the air and is scattered may be separate from the substrate container 17 for accommodating the substrate 50.

As illustrated in FIG. 5, the fluidic channel part 18 may be formed in such a manner that the air sucked into the inlet 12 passes through the light signal and is discharged from the outlet 13.

The fluidic channel part 18 may include a low-velocity part where the fluidic channel has a first cross-sectional area, and a high-velocity part where the fluidic channel has a second cross-sectional area less than the first cross-sectional area to achieve a higher velocity of the air compared to the low-velocity part.

The fluidic channel part 18 may form a non-uniform fluidic channel from the inlet 12 to the outlet 13 such that the sucked air may flow at a higher velocity.

Specifically, the air containing dust may be sucked into the inlet 12, flow through the low-velocity part having the first cross-sectional area and the high-velocity part having the second cross-sectional area, and be discharged from the outlet 13.

In this case, the low-velocity part has the first cross-sectional area that is greater than the second cross-sectional area of the high-velocity part. That is, the low-velocity part may form a wider fluidic channel compared to the high-velocity part.

Pressure may be high and the velocity of the air, which is a fluid, may be low in the wide fluidic channel of the low-velocity part, and pressure may be low and the velocity of the air may be high in the narrow fluidic channel of the high-velocity part high-velocity part.

The fluidic channel part 18 may include the low-velocity and high-velocity parts having different cross-sectional areas to increase the velocity of the air, thereby achieving an excellent effect compared to an output capacity of the fan in the inlet 12.

Although not shown in FIGS. 5 and 6, the body 10 may further include a partition. The partition may divide the body 10 into an upper part accommodating the substrate 50 and a lower part including the fluidic channel part 18 where the scattered light is generated, to detect the scattered light without interference with the substrate 50 having electronic components mounted thereon.

For example, the light emitter container 14, the lens container 15, the light receiver container 16, and the substrate container 17 may be included in the upper part as illustrated in FIG. 5, and the fluidic channel part 18 including one point where the scattered light generated when the light signal radiated from the light emitter 20 passes through the lens 30 and is scattered by the dust is received by the light receiver 40 is included in the lower part as illustrated in FIG. 4.

In this case, the inlet 12 into which the air is sucked and the outlet 13 from which the air is discharged may be provided by interconnecting the upper and lower parts. Specifically, the air may be sucked into the upper part, flow through the inlet 12 interconnecting the upper and lower parts, to the fluidic channel part 18 of the lower part, pass through the fluidic channel part 18, and be discharged from the upper part through the outlet 13 interconnecting the upper and lower parts.

As illustrated in FIG. 5, the fixing part 19 may be exposed to the outside of the shield case 60 to be firmly fixed to an external device such as an air conditioner or an air cleaner.

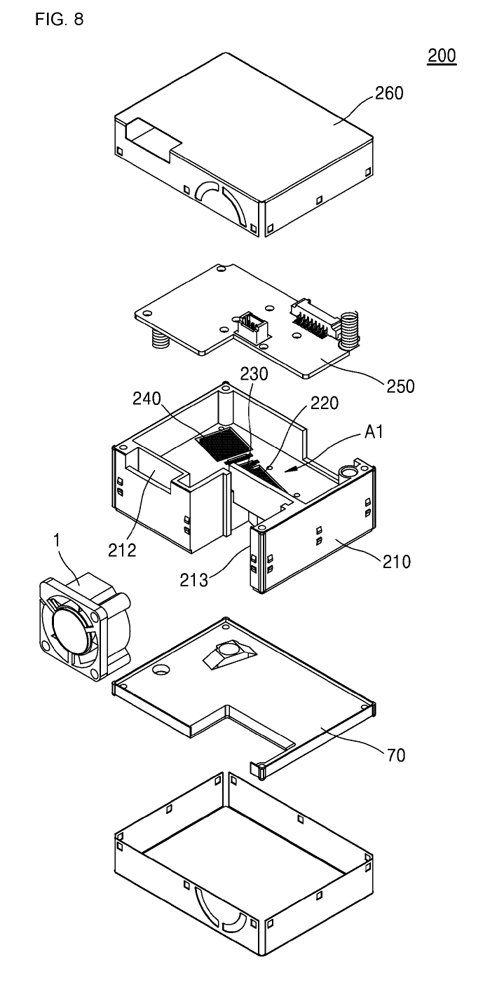

As illustrated in FIGS. 7 and 8, a dust detection apparatus 200 according to another embodiment of the present invention may include a body 210, a light emitter 220, a lens 230, a light receiver 240, and a body cover 270.

The dust detection apparatus 200 may have a hexahedron shape including the body 10 capable of detecting dust, the light emitter 220, the lens 230, the light receiver 240, and the body cover 270. An inlet 212 capable of sucking in the air containing dust may be provided in at least one surface of the hexahedron shape, and an outlet 213 capable of discharging the air may be provided in at least one surface of the hexahedron shape.

In addition to the hexahedron shape, the dust detection apparatus 200 may have various shapes such as a pillar shape (e.g., a cylinder shape or a polygonal prism shape), a corn or pyramid shape, and a plate shape so as to be installable at various places, and include an air inlet and an air outlet in at least a part thereof.

As illustrated in FIG. 8, the body 210 may suck in or discharge the air containing dust, by using a fan 1, and include a fluidic channel through which the sucked air flows at a variable velocity.

For example, a fan container capable of accommodating the fan 1 may be provided at a side of the body 210, and the fan 1 may be driven to suck in the air from outside the dust detection apparatus 200 through the inlet 212.

The air sucked into the inlet 212 may move along the fluidic channel in the body 210. In this case, the fluidic channel may form a non-uniform fluidic channel from the inlet 212 to the outlet 213 such that the sucked air may flow at a variable velocity.

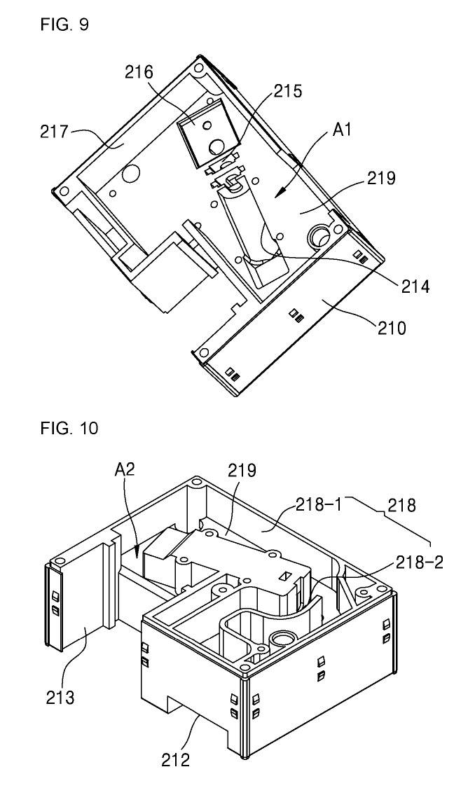

FIG. 9 is a perspective view of the body 210 of the dust detection apparatus 200, and FIG. 10 is another perspective view of the body 210.

The body 210 may include the inlet 212, the outlet 213, a light emitter container 214, a lens container 215, a light receiver container 216, a substrate container 217, and a fluidic channel part 218.

As illustrated in FIGS. 9 and 10, the inlet 212 may suck in the air containing dust, from a partial region of at least any one of external surfaces of the body 210, and the outlet 213 may discharge the air containing dust, from a partial region of at least any one of the external surfaces of the body 210.

The inlet 212 may have various shapes capable of interconnecting external and internal spaces of the body 210, and include a fan 1 for sucking in the air from outside the dust detection apparatus 200.

The inlet 212 may include a shield at a side thereof to block penetration of external light into the body 210 such that the air may be sucked through the inlet 212 into the body 210 and light may not penetrate into the body 210.

The outlet 213 may discharge the sucked air. When the fan 1 is driven, the air may be continuously sucked in, flow through the fluidic channel, and be discharged from the outlet 213 without using any driving device for discharging the air.

That is, the fan 1 may perform both of the air suction function and the air discharge function.

The outlet 213 may include a shield at a side thereof to block penetration of external light into the body 210 such that the air may be discharged from the body 10 through the outlet 213 and light may not penetrate into the body 210.

As illustrated in FIGS. 8 and 9, the light emitter container 214 may accommodate the light emitter 220, the light emitter 220 may be provided in the body 210 to radiate a light signal by using a laser device, the lens container 215 may accommodate the lens 230, the lens 230 may be provided in the body 210 to concentrate the light signal radiated from the laser device, the light receiver container 216 may accommodate the light receiver 240, the light receiver 240 may be provided in the body 210 to detect scattered light generated when the radiated light signal is scattered by the dust in the air, and the substrate container 217 may accommodate a substrate 250 having electronic components mounted thereon.

In this case, the light emitter container 214 and the light receiver container 216 may be integrated with each other to uniformly deliver the light signal to the light receiver 240.

The light emitter 220, the light emitter container 214, the lens 230, the lens container 215, the light receiver 240, the light receiver container 216, the substrate 250, and the substrate container 217 may correspond to the light emitter, the light emitter container, the lens, the lens container, the light receiver, the light receiver container, the substrate, and the substrate container of the dust detection apparatus 100 and will now be described in detail.

As illustrated in FIGS. 9 and 10, the body 210 may further include a partition 219.

The partition may divide the body 210 into a first region A1 accommodating the substrate 250 and a second region A2 including the fluidic channel where the scattered light is generated, to detect the scattered light without interference with the substrate 250 having electronic components mounted thereon.

For example, as illustrated in FIG. 9, the light emitter container 214, the lens container 215, and the light receiver container 216 may be included and the substrate container 217 may be further included in the first region A1.

The light emitter container 214, the lens container 215, the light receiver container 216, and the substrate container 217 may be provided at a side of the partition 219.

In this case, a light signal hole may be generated in such a manner that the light signal radiated from the light emitter 220 accommodated in the light emitter container 214 may proceed toward the second region A2, and a scattered light hole may be generated in such a manner that the scattered light may be received by the light receiver 240 accommodated in the light receiver container 216.

As illustrated in FIG. 10, the inlet 212 for sucking in the air and the outlet 213 for discharging the air may be included and the fluidic channel including one point where the scattered light generated when the light signal radiated from the light emitter 220 passes through the lens 230 and is scattered by the dust is received by the light receiver 240 may be further included in the second region A2.

Specifically, the first and second regions A1 and A2 may be divided by the partition 219 and the fluidic channel part 218 may be included only in the second region A2 such that the light signal radiated from the light emitter 220 may collide with the dust and the scattered light may be received by the light receiver 240 without interference with, for example, the light emitter 220, the light receiver 240, and the substrate 250.

A structure for detecting the scattered light without interference with the substrate 250 may be configured by dividing the first and second regions A1 and A2 by using the partition 219, and more of the scattered light may be delivered well to the light receiver 240.

As illustrated in FIG. 10, the fluidic channel part 218 may be formed in such a manner that the air sucked into the inlet 212 passes through the light signal and is discharged from the outlet 213.

The fluidic channel part 218 may form a non-uniform fluidic channel from the inlet 212 to the outlet 213 such that the sucked air may flow at a higher velocity.

The fluidic channel part 218 may include a low-velocity part 218-1 where the fluidic channel has a first cross-sectional area, and a high-velocity part 218-2 where the fluidic channel has a second cross-sectional area less than the first cross-sectional area to achieve a higher velocity of the air compared to the low-velocity part 218-1. Specifically, the air containing dust may be sucked into the inlet 212, flow through the high-velocity part 218-2 having a second cross-sectional area and the low-velocity part 218-1 having the first cross-sectional area, and be discharged from the outlet 213.

In this case, the low-velocity part 218-1 has the first cross-sectional area that is greater than the second cross-sectional area of the high-velocity part 218-2. That is, the low-velocity part 218-1 may form a wider fluidic channel compared to the high-velocity part 218-2.

Pressure may be high and the velocity of the air, which is a fluid, may be low in the wide fluidic channel of the low-velocity part 218-1, and pressure may be low and the velocity of the air may be high in the narrow fluidic channel of the high-velocity part high-velocity part 218-2.

The fluidic channel part 218 may include the low-velocity and high-velocity parts 218-1 and 218-2 having different cross-sectional areas to increase the velocity of the air, thereby achieving an excellent effect compared to an output capacity of the fan 1 in the inlet 212.

That is, scattered light may be sufficiently obtained using a low-speed fan which may increase a lifespan and produce less vibration and noise compared to a high-speed fan.

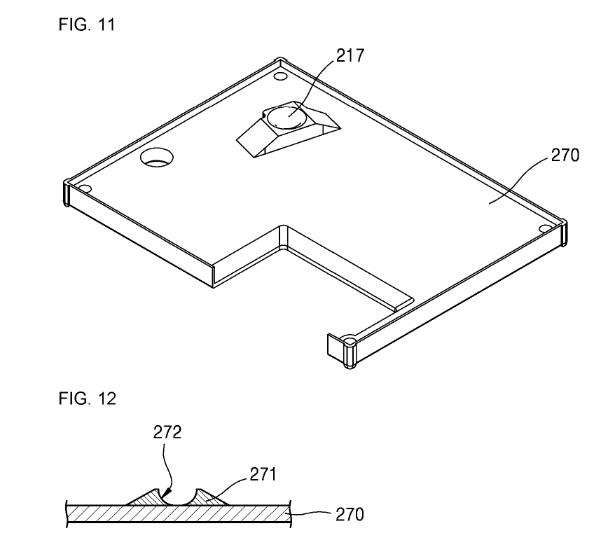

FIG. 11 is a perspective view of the body cover 270 of the dust detection apparatus 200 according to another embodiment of the present invention, and FIG. 12 is a cross-sectional view of a condenser 271 of FIG. 11.

As illustrated in FIGS. 8 and 11, the body cover 270 may include a condenser 271 capable of concentrating the scattered light on the light receiver 240, and be provided at a side of the body 210.

The body cover 270 may cover the fluidic channel formed at a side of the body 210, and include the condenser 271 for concentrating the scattered light on the light receiver 240.

Specifically, the body cover 270 may cover the second region A2 including the fluidic channel part 218.

As illustrated in FIGS. 8, 11, and 12, the condenser 271 may include a concave part 272 in a direction opposite to a direction toward the light receiver 240 with respect to the fluidic channel to concentrate the light scattered in a direction different from the direction toward the light receiver 240, and reflect the scattered light incident on the concave part 272, to the light receiver 240.

Some of the scattered light may be directly delivered to the light receiver 240. The light scattered in the direction different from the direction toward the light receiver 240 may be concentrated on the light receiver 240 through the condenser 271.

Specifically, the condenser 271 may be provided in the direction different from the direction toward the light receiver 240 to reflect the light scattered in the different direction, to the light receiver 240. For example, the condenser 271 may be provided in the direction opposite to the direction toward the light receiver 240 to reflect and deliver the light scattered in the direction opposite to the direction toward the light receiver 240, to the light receiver 240.

The condenser 271 may form a flat reflector when the scattered light is reflected and delivered to the light receiver 240, and include the concave part 272 to concentrate the scattered light.

As illustrated in FIG. 8, the dust detection apparatus 200 according to another embodiment of the present invention may further include a sensor for amplifying a signal output from the light receiver 240, and determining a dust concentration by using a microcomputer, and a shield case 260 surrounding the body 210.

The sensor may be a controller for controlling the light emitter 220 and the light receiver 240, and may control the light emitter 220 to radiate the light signal onto one point of the fluidic channel by applying an output signal thereof to the light emitter 220. The controller may further include an amplifier for amplifying the scattered light signal, and a corrector for removing noise from the scattered light signal.

The shield case 260 may include a first case and a second case, and the first and second cases may be coupled to the body 210 by using bolts. Alternatively, as described above in relation to the dust detection apparatus 100 according to an embodiment of the present invention, the first and second cases may include coupling parts including protrusions and holes or recesses and be assembled without using bolts, and may accommodate and fix the body 210 therein.

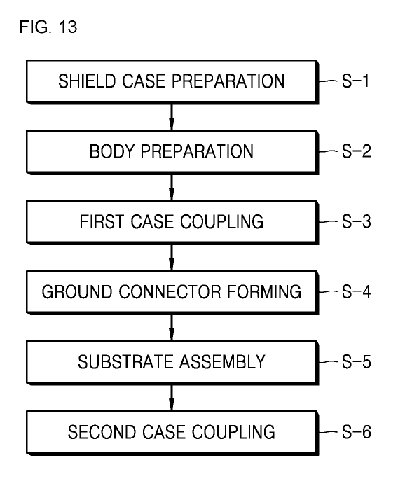

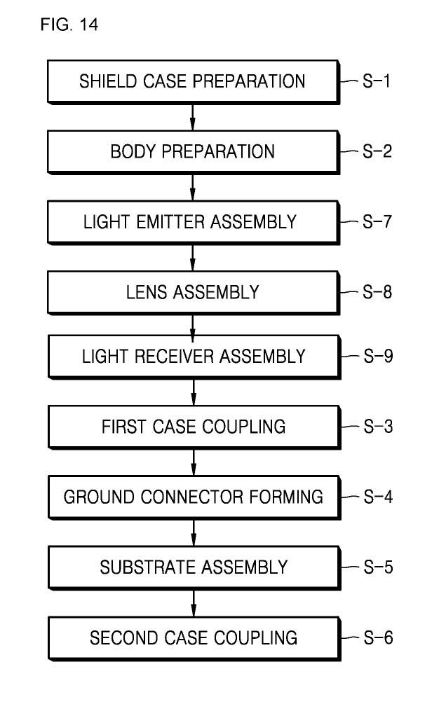

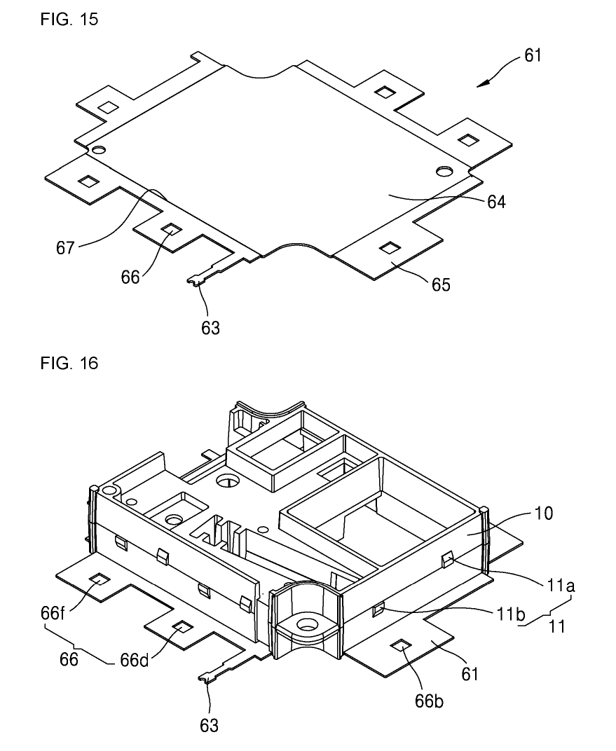

FIG. 13 is a flowchart of a method of manufacturing the dust detection apparatus 100, according to an embodiment of the present invention, FIG. 14 is a flowchart of a method of manufacturing the dust detection apparatus 100, according to another embodiment of the present invention, and FIGS. 15 to 22 are perspective and magnified views showing operations of the method of manufacturing the dust detection apparatus 100.

As illustrated in FIG. 13, the method of manufacturing the dust detection apparatus 100, according to an embodiment of the present invention, may include a shield case preparation operation S-1, a body preparation operation S-2, a first case coupling operation S-3, a ground connector forming operation S-4, a substrate assembly operation S-5, and a second case coupling operation S-6.

As illustrated in FIG. 15, the shield case preparation operation S-1 is an operation for preparing the shield case 60 including the first case 61 capable of covering a lower part of the body 10 and the second case 62 capable of covering an upper part of the body 10.

Specifically, in the shield case preparation operation S-1, the shield case 60 including the plane part 64, the side part 65, the case fixing holes 66, and the ground connector 63 may be prepared. Descriptions of the plane part 64, the side part 65, the case fixing holes 66, and the ground connector 63 are provided above.

The shield case 60 may further include a bending part 67 that is easily bendable. For example, the bending part 67 may be configured as a stepped part between the plane part 64 and the side part 65 to easily bent each side of the hexahedral first or second case 61 or 62 to be coupled to the body 10, or be configured as a recessed part easily bendable between the plane part 64 and the side part 65.

As illustrated in FIG. 16, the body preparation operation S-2 is an operation for preparing the body 10 including the fluidic channel part 18 formed in such a manner that the air sucked into the inlet 12 passes through the light signal and is discharged from the outlet 13.

Specifically, in the body preparation operation S-2, the body 10 including the fixing protrusions 11, the inlet 12, the outlet 13, the light emitter container 14, the lens container 15, the light receiver container 16, the substrate container 17, the fluidic channel part 18, and the fixing part 19 may be prepared. Descriptions of the fixing protrusions 11, the inlet 12, the outlet 13, the light emitter container 14, the lens container 15, the light receiver container 16, the substrate container 17, the fluidic channel part 18, and the fixing part 19 of the body 10 are provided above.

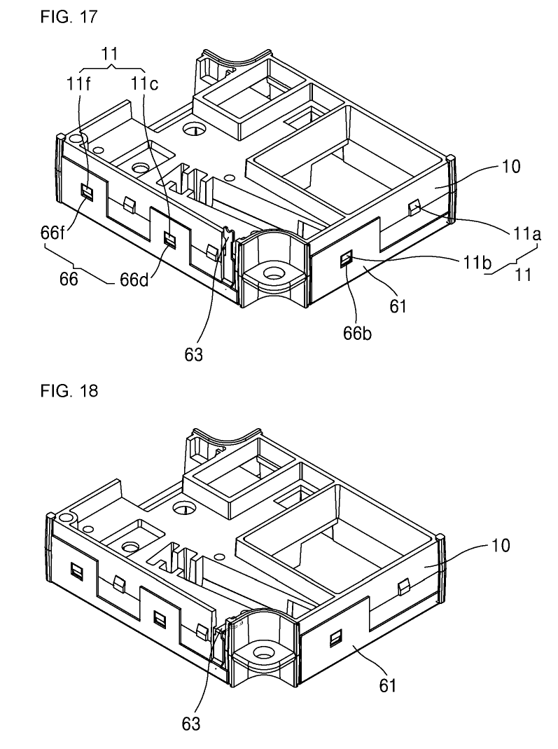

As illustrated in FIG. 17, the first case coupling operation S-3 is an operation for bending the first case 61 to be coupled to and to cover the upper part of the body 10.

Specifically, in the first case coupling operation S-3, the case fixing holes 66b, 66d, and 66f of the first case 61 may be correspondingly coupled to the fixing protrusions 11b, 11d, and 11f of the body 10.

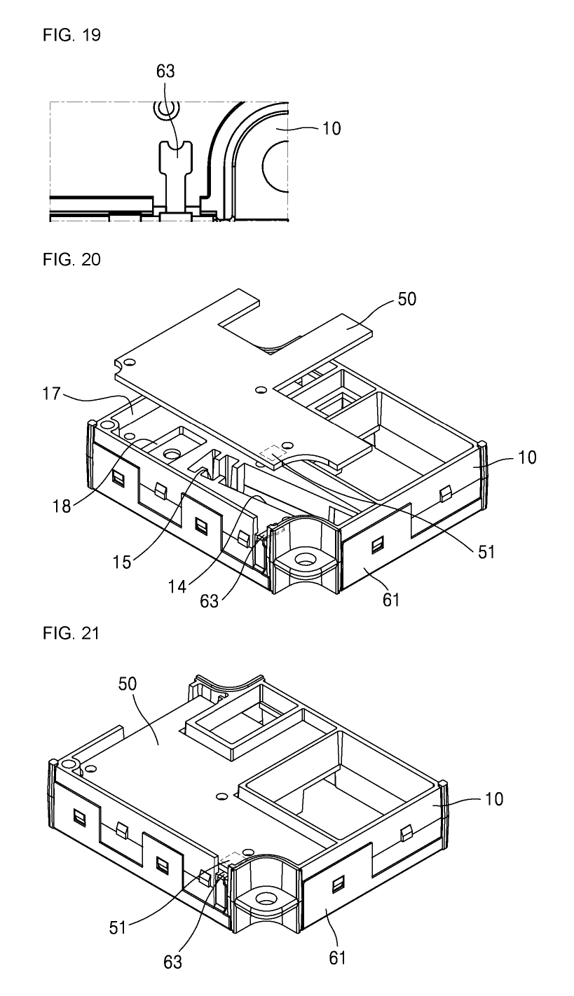

As illustrated in FIGS. 18 and 19, the ground connector forming operation S-4 is an operation for bending at least a part of the ground connector 63 of the first case 61 into the body 10.

Specifically, in the ground connector forming operation S-4, the ground connector 63 extending from a side of the first case 61 to a certain length may be bent along a ground connector guide at a side of the body 10 and be coupled to the body 10.

As illustrated in FIG. 19, the ground connector 63 coupled to the body 10 may be previously formed on the lower part to which the substrate 50 is assembled.

As illustrated in FIGS. 20 and 21, the substrate assembly operation S-5 is an operation for assembling the substrate 50 having electronic components mounted thereon, to the body 10 in such a manner that a ground terminal 51 on the substrate 50 is in contact with the ground connector 63.

Specifically, in the substrate assembly operation S-5, the substrate 50 may be assembled onto the ground connector 63 in such a manner that the ground terminal 51 on the substrate 50 is in contact with the ground connector 63 coupled to the body 10.

Alternatively, the ground connector 63 may be bent and be coupled to the body 10 after the substrate 50 is assembled in the substrate assembly operation S-5. Due to a springback phenomenon based on internal elastic force of the ground connector 63 bent from the first case 61, force of contact between the ground connector 63 and the substrate 50 assembled onto the ground connector 63 in a direction in which the ground connector 63 is bent may be increased.

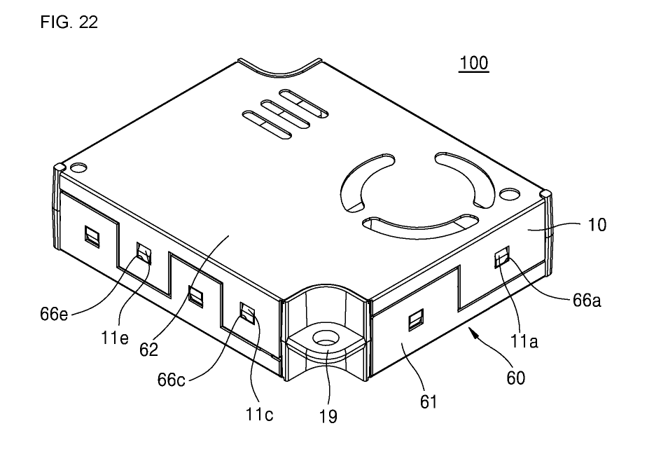

As illustrated in FIG. 22, the second case coupling operation S-6 is an operation for coupling and covering the second case 62 to and on the lower part of the body 10.

Specifically, in the second case coupling operation S-6, the case fixing holes 66a, 66c, and 66e of the second case 62 may be correspondingly coupled to the fixing protrusions 11a, 11c, and 11e of the body 10.

As illustrated in FIG. 14, the method of manufacturing the dust detection apparatus 100, according to another embodiment of the present invention, may further include a light emitter assembly operation S-7, a lens assembly operation S-8, and a light receiver assembly operation S-9 after the body preparation operation S-2.

The light emitter assembly operation S-7 is an operation for assembling the light emitter 20 for radiating a light signal by using a laser device, to the body 10, the lens assembly operation S-8 is an operation for assembling the lens 30 capable of concentrating the light signal radiated from the laser device, to the body 10, and the light receiver assembly operation S-9 is an operation for assembling the light receiver 40 for detecting scattered light generated when the radiated light signal is scattered by dust in the air, to the body 10.

The above-described dust detection apparatus 100 may reduce ground resistance, increase a noise cancellation effect, and prevent an increase in contact resistance due to corrosion of any medium by directly assembling the shield case 60 to the ground terminal 51 of the substrate 50 without using the medium by applying the shield case 60 including the ground connector 63.

As described above, according to an embodiment of the present invention, a dust detection apparatus capable of reducing ground resistance, increasing a noise cancellation effect, and preventing an increase in contact resistance due to corrosion of any medium such as a spring by directly assembling a shield case to a ground terminal of a printed circuit board (PCB) without using the medium by applying the shield case including a ground connector, to a dust sensor, and a method of manufacturing the dust detection apparatus may be provided.

According to another embodiment of the present invention, a dust detection apparatus capable of sufficiently obtaining scattered light by using a low-speed fan by forming a fluidic channel in a Venturi structure, of reducing costs for designing a circuit for amplifying a light signal, by sufficiently receiving reflected light other than directly reflected light by concentrating the scattered light, and of minimizing errors of a light emitter and a light receiver by integrating the light emitter (e.g., a laser device) and the light receiver with one body may be provided. However, the scope of the present invention is not limited to the above-described effects.

While the present invention has been particularly shown and described with reference to embodiments thereof, it will be understood by one of ordinary skill in the art that various changes in form and details may be made therein without departing from the scope of the present invention as defined by the following claims.

What is claimed is:

1. A dust detection apparatus comprising:
a body capable of sucking in or discharging air containing dust, by using a fan, and comprising a fluidic channel through which the sucked air flows;
a light emitter provided in the body to radiate a light signal by using a laser device;
a lens provided in the body to concentrate the light signal radiated from the laser device;
a light receiver provided in the body to detect scattered light generated when the radiated light signal is scattered by the dust in the air;
a substrate provided in the body to mount electronic components thereon; and
a shield case surrounding the body to be at least partially in contact with the substrate.

2. The dust detection apparatus of claim 1, wherein the shield case comprises a ground connector at least partially bent into the body to be in direct contact with a ground terminal on the substrate.

3. The dust detection apparatus of claim 1, wherein the body comprises a plurality of fixing protrusions provided on side walls of the body, and
wherein the shield case comprises:
a plane part corresponding to a surface of the body;
a side part corresponding to the side walls of the body; and
a plurality of case fixing holes provided in the side part in a shape corresponding to the fixing protrusions so as to fix the shield case to the body.

4. The dust detection apparatus of claim 1, wherein the shield case comprises:
a first case covering a lower part of the body; and
a second case covering an upper part of the body, and
wherein at least a part of at least any one of the first and second cases is in contact with the substrate.

5. The dust detection apparatus of claim 1, wherein the body comprises a fixing part exposed to outside of the shield case to be fixed to an external device.

6. A dust detection apparatus comprising:
a body capable of sucking in or discharging air containing dust, by using a fan, and comprising a fluidic channel through which the sucked air flows at a variable velocity;
a light emitter provided in the body to radiate a light signal by using a laser device;
a lens provided in the body to concentrate the light signal radiated from the laser device;
a light receiver provided in the body to detect scattered light generated when the radiated light signal is scattered by the dust in the air; and
a body cover comprising a condenser capable of concentrating the scattered light on the light receiver, and provided at a side of the body.

7. The dust detection apparatus of claim 6, wherein the body comprises a partition for dividing the body into a first region accommodating a substrate and a second region comprising the fluidic channel where the scattered light is generated, to detect the scattered light without interference with the substrate having electronic components mounted thereon.

8. The dust detection apparatus of claim 6, wherein the condenser comprises a concave part in a direction opposite to a direction toward the light receiver with respect to the fluidic channel to concentrate the light scattered in a direction different from the direction toward the light receiver, and reflects the scattered light incident on the concave part, to the light receiver.

9. The dust detection apparatus of claim 6, further comprising a shield case surrounding the body.

10. The dust detection apparatus of claim 1, wherein the body comprises:
an inlet capable of sucking in the air containing dust, from a partial region of at least any one of external surfaces of the body;
an outlet capable of discharging the air containing dust, from a partial region of at least any one of the external surfaces of the body;
a light emitter container capable of accommodating the light emitter;
a lens container capable of accommodating the lens;
a light receiver container capable of accommodating the light receiver;
a substrate container for accommodating a substrate having electronic components mounted thereon; and
a fluidic channel part formed in such a manner that the air sucked into the inlet passes through the light signal and is discharged from the outlet.

11. The dust detection apparatus of claim 10, wherein the fluidic channel part comprises:
a low-velocity part where the fluidic channel has a first cross-sectional area; and
a high-velocity part where the fluidic channel has a second cross-sectional area less than the first cross-sectional area to achieve a higher velocity of the air compared to the low-velocity part.

12. The dust detection apparatus of claim 10, wherein the light emitter container and the light receiver container are integrated with each other to uniformly deliver the light signal to the light receiver.

13. The dust detection apparatus of claim 1, further comprising a sensor for amplifying a signal output from the light receiver, and determining a dust concentration by using a microcomputer.

14. The dust detection apparatus of claim 6, wherein the body comprises:
an inlet capable of sucking in the air containing dust, from a partial region of at least any one of external surfaces of the body;
an outlet capable of discharging the air containing dust, from a partial region of at least any one of the external surfaces of the body;
a light emitter container capable of accommodating the light emitter;
a lens container capable of accommodating the lens;
a light receiver container capable of accommodating the light receiver;
a substrate container for accommodating a substrate having electronic components mounted thereon; and
a fluidic channel part formed in such a manner that the air sucked into the inlet passes through the light signal and is discharged from the outlet.

15. The dust detection apparatus of claim 14, wherein the fluidic channel part comprises:
a low-velocity part where the fluidic channel has a first cross-sectional area; and
a high-velocity part where the fluidic channel has a second cross-sectional area less than the first cross-sectional area to achieve a higher velocity of the air compared to the low-velocity part.

16. The dust detection apparatus of claim 14, wherein the light emitter container and the light receiver container are integrated with each other to uniformly deliver the light signal to the light receiver.

17. The dust detection apparatus of claim 6, further comprising a sensor for amplifying a signal output from the light receiver, and determining a dust concentration by using a microcomputer.

18. A method of manufacturing a dust detection apparatus, the method comprising:
a shield case preparation operation for preparing a shield case comprising a first case capable of covering a lower part of a body and a second case capable of covering an upper part of the body;
a body preparation operation for preparing the body comprising a fluidic channel part formed in such a manner that air sucked into an inlet passes through a light signal and is discharged from an outlet;
a first case coupling operation for bending the first case to be coupled to and to cover the upper part of the body;
a ground connector forming operation for bending at least a part of a ground connector of the first case into the body;
a substrate assembly operation for assembling a substrate having electronic components mounted thereon, to the body in such a manner that a ground terminal on the substrate is in contact with the ground connector; and
a second case coupling operation for coupling and covering the second case 62 to and on the lower part of the body.

19. The method of claim 18, further comprising, after the body preparation operation:
a light emitter assembly operation for assembling a light emitter for radiating a light signal by using a laser device, to the body;
a lens assembly operation for assembling a lens capable of concentrating the light signal radiated from the laser device, to the body; and
a light receiver assembly operation for assembling a light receiver for detecting scattered light generated when the radiated light signal is scattered by dust in the air, to the body.
